(19) United States
(12) Patent Application Publication
(10) Pub. No.: US 2005/0278419 A1
(43) Pub. Date: Dec. 15, 2005

(54) System and method for linking resources with actions

(76) Inventor: Robert P. Morris, Raleigh, NC (US)

Correspondence Address: SAWYER LAW GROUP, LLP, PO BOX 51458, PAL ALTO, CA, 94303, US

(21) Appl. No.: 10/868,550

(22) Filed: Jun. 14, 2004

(51) Int. Cl. G06F 15/16

(52) U.S. Cl. 709/203

(57) ABSTRACT

The invention provides a method and system for linking resources with actions. A client device is configured to receive an action request and has a configuration specific to the client device. The client device has access to a resource map that associates the action request with a resource-category, and in response to receiving the action request, uses the resource map to retrieve a program for executing the action request. The client device is further configured to execute the program to perform the action request. A server is configured to communicate with the client device over a network, to maintain the resource map, and to provide the resource map to the client device.

### FIELD OF THE INVENTION

The invention relates generally to executing software and specifically to linking resources with actions.

### BACKGROUND OF THE INVENTION

Computers exist in a variety of devices, from desktop computers (PC), to watches, cell phones, cameras, personal digital assistants (PDA), vehicles, and so forth. Most of these and other systems provide different mechanisms with which a user may interact with the computer. Cell phones, cameras and watches have buttons, PDAs may have a stylus, a desktop computer may have a keyboard and a mouse with buttons, and so forth.

These computers all have an operating system (OS), with each OS designed for its particular computer. For example, WINDOWS, OS/X, LINUX, other UNIX variants are all examples of an OS for desktop computers, while WINDOWS CE is an OS for a PDA. The OS is generally not interchangeable between different types of devices (e.g. a PC and a cell phone).

One function of an OS is to interpret user input to a device. Input may be the press of a button or key, rotation of a knob, movement of a slide, a voice command, and so on. The input is correlated to an action by the device and different actions are often associated by the OS with different programs that can execute the action. For example, pressing the shutter button on a camera while in shooting mode may cause the camera to take a picture. On the other hand, pressing the shutter button while the camera is connected to a PC may cause a picture to download to the PC.

The example most familiar to users is the open action performed with a PC. A user may right-click on a resource, or file, name in an open window on their PC and a menu is displayed typically with the ‘open’ action at or near the top. Each resource has a resource-category, for example text, graphics, music, etc. Different resource-categories have different sets of actions available. For example, text and graphics resource-categories have an open action associated with them. If the ‘open’ action is selected a text resource is passed to the program for executing this action. For example, if the document is a MICROSOFT Word document, Word is typically the program associated with open for that resource-category. If the resource is a jpeg file, an available browser such as NETSCAPE or MICROSOFT INTERNET EXPLORER is the program most often associated with the open action.

Although conventional operating systems automate the process of finding applications that can operate on a file or other resource, this process is limited in that the programs that may be associated with actions, and thus the possible actions, are restricted to local or network attached storage. The menus and actions that the programs contain are specific to the machine the user is using. That is, if a user opens a resource that is associated with a program not present on a device, the device responds by informing the user that the program cannot be found and that the action cannot be taken or the action option might not appear at all.

In a business environment it would be useful to provide a custom set of actions mapped to a standard set of programs for a set of resource categories, so that users consistently use the same programs when invoking actions on resources. Further, it would be desirable that all users use compatible versions of the same programs.

Accordingly, what is needed is a method and system for linking resources with actions, and expanding the range of actions for a given resource-category. The invention addresses this need.

### SUMMARY OF THE INVENTION

The invention provides a method and system for linking resources with actions. According to the present invention, a client device is configured to receive an action request and has a configuration specific to the client device. The client device has access to a resource map that associates the action request with a resource-category, and in response to receiving the action request, uses the resource map to retrieve a program for executing the action request. The client device is further configured to execute the program to perform the action request. Finally, a server is configured to communicate with the client device over a network, to maintain the resource map, and to provide the resource map to the client device.

According to the present invention, the method and system extend the range of available actions beyond those available on local or network attached storage and allow actions and associated software to be centrally managed and tracked. The present invention allows upgrades to be installed in one location that automatically distributes the upgrades on an as needed basis and it allows software associated with actions to be stored remotely and used by the client on an as needed basis. This is significant for handhelds and other devices with limited resources, e.g. cell phones, digital camera, PDAs, etc.

### BRIEF DESCRIPTION OF THE DRAWING(S)

FIG. 1 is a block diagram of one embodiment of a system for linking resources with actions through a resource map.

FIG. 2 is a flow diagram illustrating one embodiment of a method for linking resources with actions through a resource map.

FIG. 3 is a block diagram illustrating one embodiment of the invention within a drop-down window of a context menu.

FIG. 4 is a block diagram illustrating one embodiment of the invention within a photo-display environment.

FIG. 5 is a block diagram illustrating one embodiment of a software structure for implementing the present invention within a client device.

FIG. 6 is a block diagram illustrating one embodiment of the invention in a server.

### DETAILED DESCRIPTION OF THE INVENTION

The present invention relates generally to executing software and specifically to linking resources with actions. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the invention is not intended to be limited to the embodiment shown but is to be accorded the widest scope consistent with the principles and features described herein.

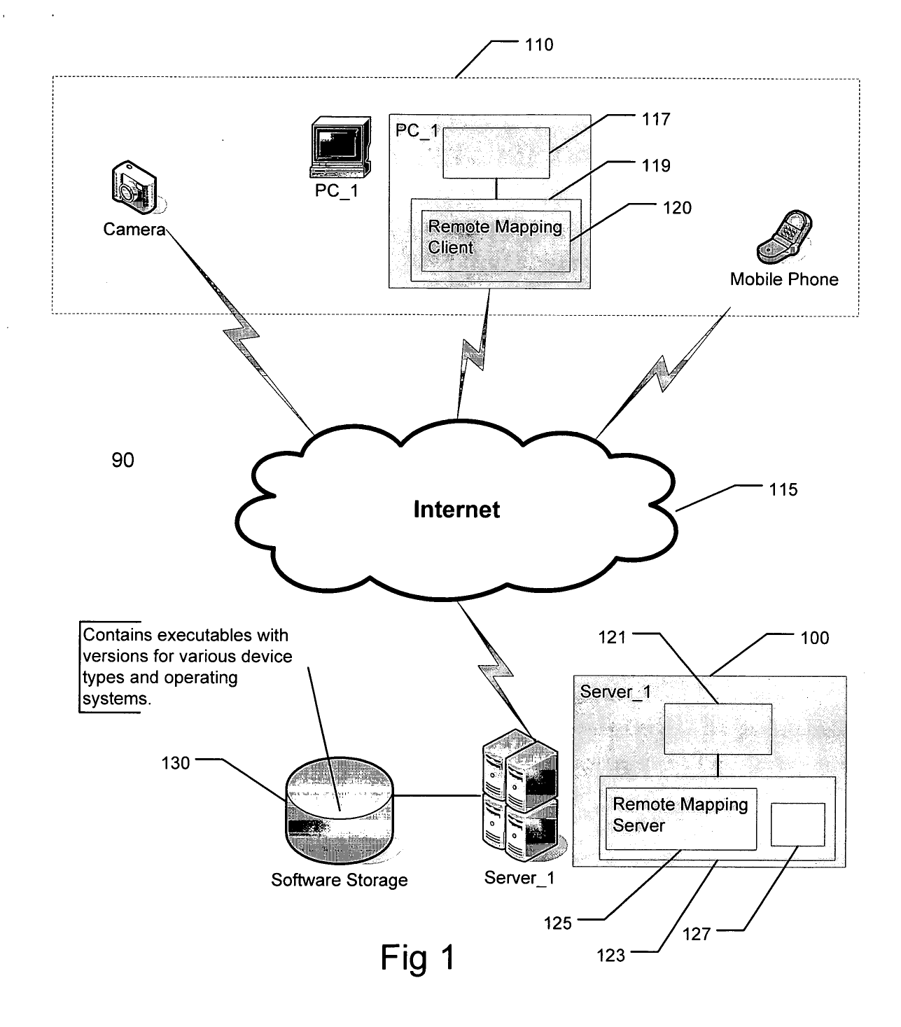

FIG. 1 is a block diagram of one embodiment of system for linking resources with actions through a resource map. System 90 includes server 100 connected to client devices 110 through network 115. Example types of client devices 110 include a PC, a camera, and a mobile phone, for instance. One example of a network is the Internet.

Each client device 110 includes processor 117 and connected memory 119. Similarly, server 100 includes processor 121 and memory 123. There are many different processor and memory combinations suitable for different client devices and servers. Server 100 connects to storage 130, which may be internal or external to server 100, and may be remotely accessed.

According to the present invention, memory 119 of client device 110 is provided with Remote Mapping Client (RMC) software application 120, while memory 123 of server 100 is provided with Remote Mapping Server (RMS) software application 125. RMS application 125 maintains one or more resource maps 127, which may be stored and maintained in memory 123, or alternatively in storage 130.

Resource map 127 is a customizable list of resource mappings. Each of the resource mappings associates a resource-category with an action map. Resource-categories include, for example, graphics, music, word processing, spreadsheets, database tables, database records, etc. Each action map contains action mappings each of which associates an action request with a program for executing the action request. Examples of actions requests include the press of a button or key, the slide of a lever, the turn of a knob, a voice command, or any other input to a device that relates to a resource associated the device. Typically actions are identified by name and appear on user interface controls such as a context menu associated with a resource. An executed action, i.e. pressing a key or button or selecting an item within a context menu, for example, becomes an action request on the relevant resource associated with the device. A standard set of actions may already be mapped to a given resource-category, and the invention allows the standard set to be modified or expanded.

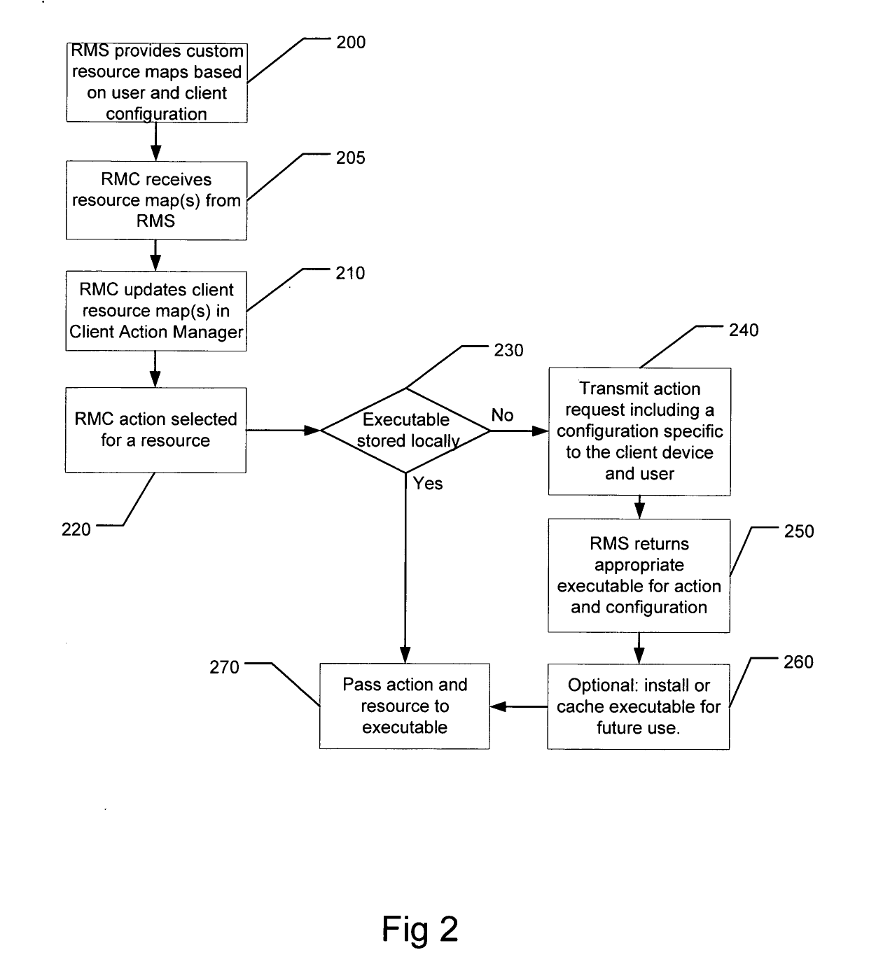

FIG. 2 is a flow diagram illustrating one embodiment of a method for linking resources with actions through a resource map. The following example is provided with reference to FIGS. 1 and 2.

In block 200, RMS 125 on server 100 makes one or more resource maps 127 available for RMC application 120. The resource maps 127 may be optionally customized based on the configuration specific to each of devices 110 and the users of devices 110. Block 200 may be performed once, it may already be established for a given user or group, or it may be performed numerous times.

In block 205, RMC application 120 receives resource map 127 from server 100. This step may occur for client devices 110 upon initialization, at regular or irregular intervals. Resource map 127 may be transmitted to RMC application 120 by the initiative of RMS 125 or RMC application 120 may request resource map 127. Client devices 110 may store resource map 127 in memory 119 or elsewhere, as long as RMC application 120 has access to resource map 127 (now loaded on client device 110).

In block 210, RMC application 120 uses resource map 127 to associate action requests with specific resources and/or resource-categories in client device 110. Typically this is done by updating the resource maps maintained by the system referred to as the Client Action Manager. For example, various versions of MICROSOFT WINDOWS maintain a resource map with resource mappings as mappings of file types to actions where file types are identified using file name extensions. One use of resource mapping in MICROSOFT WINDOWS is to display context menus when a user initiates certain actions. For example, in client device 110 a user may right-click (select) a resource with a mouse (not shown), bringing up a context menu. If the resource is a text document, one of the standard sets of actions in the context menu will be ‘open.’ A resource map added action might be ‘email document,’ which could open a mail program and open a new message within the email program, automatically attaching the selected resource to the new message. The user would then provide the recipient's address and send it. Other operating systems provide their own embodiments of resource maps.

In a context menu according to one embodiment of the invention, some or all of the actions may be from resource map 127, and some or none of them may be from the standard set of actions. The actions available through resource map 127 may appear directly in a standard menu of actions, or it may appear as a separate, sub-menu of the context menu.

After the user selects an action from the context menu the action becomes a request to client device 110 to perform the action, or an action request in block 220. If the action mapping associates the request with an action provided by RMC application 120, in block 230 RMC application 120 determines whether a program for executing the action request is directly accessible to client device 110.

If a program for executing the action request is not available to client device 110, then in block 240, client device 110 requests the executable by transmitting the action request and a configuration specific to the client device to server 100. Typically, programs are accessible when they are in memory 119 of client device 110, for example, or in some other memory or storage immediately attached to client device 110. Programs available through a network are not considered immediately accessible with respect to the invention.

The configuration information is specific to client device 110 and may include the processor type, memory size, operating system (OS), and user information, etc. The configuration information should include sufficient data such that a program appropriate to the operating environment of client device 110 may be selected for executing the action.

RMS application 125 in server 100 receives the action request and the configuration specific to client device 110. The configuration of client device 110 provides RMS application 125 with configuration information in order that a version of the program that will operate on client device 110 may be identified. Programs for executing an action request on different configurations of client device 110 may be located in storage 130, which may be a database. If RMS application 125 identifies an appropriate program in storage 130, then in block 250 RMS application 125 transmits the program to client device 110 through network 115.

In block 260, client device 110 receives the executable and may optionally install or cache the program for future use. Client device 110 may save the program to memory 119, update an older version of the program already in a long-term memory, or discard the program after some use.

In block 270, RMC application 120 transmits the action request and the resource upon which the action request was made to the program for execution.

In another embodiment, different resource maps may be loaded into client devices 110. Each resource map may belong to a different user, a different group of users, a single user with different interests, or other combinations. Each resource map may associate a different set of actions with a different set of resource-categories, depending on preference or need.

In another embodiment, the action request is transmitted to server 100, which then runs a program for executing the action request.

One of ordinary skill in the art will recognize that various licensing requirements may have to be met before legally operating the invention, specifically licensing arrangements between the owners of programs in storage 130 and the owners of client devices 110.

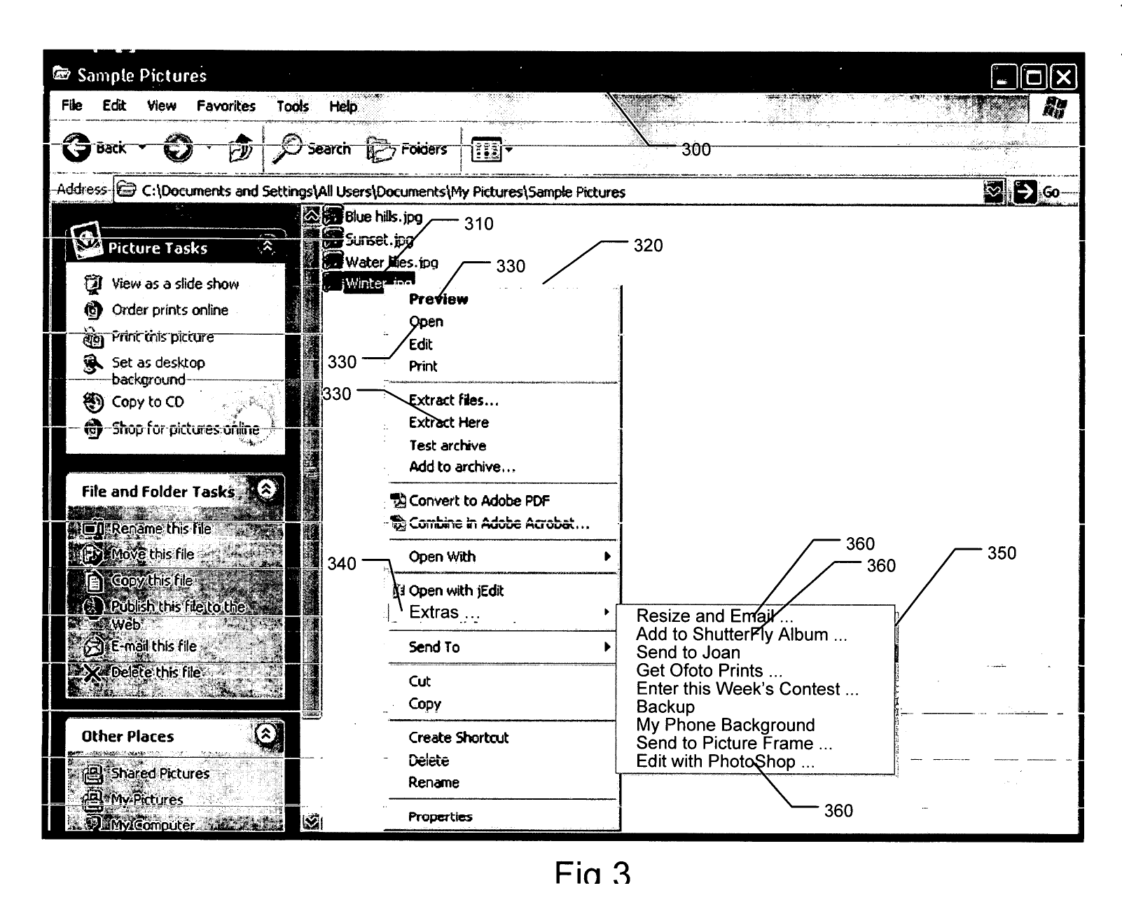

FIG. 3 is a block diagram illustrating one embodiment of the invention within a drop-down window of a context menu, for example in client device 110 of FIG. 1. In FIG. 3, a list of resources with extension “jpg” is illustrated in a window 300, “Sample Pictures” contains several resources, including resource 310, “Winterjpg.” The following is one example of using the invention.

A user has selected resource 310 (indicated by highlighting) by performing a right-click an a mouse, causing context menu 320 to appear with a list of standard of actions associated with resource 310, or with resources that are of the same resource-category as resource 310 (jpg resources, in this example). Context menu 320 includes different actions associated with the right-click of a mouse. One set of options, labeled “Extras” 340, includes context sub-menu 350 with actions 360 associated with JPEG resource-categories. In this embodiment, resource map 127 (see FIG. 1) contained the associations between actions 360 and JPEG resource-categories. RMC application 120 established resource map 127 in context menu 320 as sub-menu 350.

In another embodiment, actions 360 may appear embedded directly within context menu 320 along with actions 330. The range of actions available in resource map 127 is customizable to the particular client device, a particular user, within a particular environment, etc.

Continuing with the above example, the user then selects one of actions 360, at which time RMC application 120 determines whether the particular program to execute action 360 is accessible to client device 110 (typically in long-term storage, such as a hard drive or flash memory). If the program is not locally available, or if there is a newer version with which RMC application 120 has associated action 360, then RMC application 120 transmits an action request (i.e. the selection of action 360) and the configuration for client device 110 to server 100. Server 100 compares the configuration requirements and action request with programs in storage 130 and transmits an appropriate program to client device 110, if available.

In one embodiment, client device 110 has a program in memory for executing the action request, however a newer version of the program exists in storage 130 and during an update, RMC application 120 has changed the association from the old version to the new version accessible to server 100. The update may not occur until a user actually needs to execute an action request. Conversely, it is not necessary that RMC application 120 change the association with each new version of a program, however this is one manner of standardizing usage among a group.

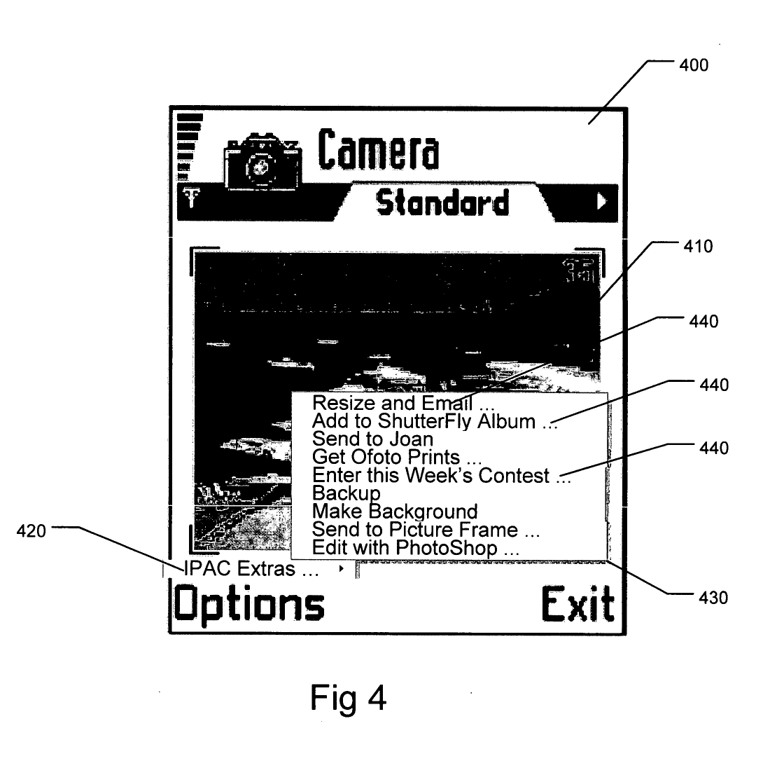

FIG. 4 is a block diagram illustrating one embodiment of the invention within a photo-display environment, for example digital camera client device 110 of FIG. 1. In FIG. 4, screen image 400 may be displayed on a client device 110, for example a digital camera. Client device 110 may be in a photo-review mode, with image 410 currently selected in screen image 400. A user having selected “Extras” 420 may see context menu 430, with actions 440 available.

As with the previous example, the following example is described with reference to FIGS. 1 and 4. A user operating client device 110 with an RMC application (not shown) selects image 410. After sliding a lever, pressing a button, or other appropriate selection method, the user selects “Extras” 420 and context menu 430 appears. The user then selects one of actions 440, at which time the RMC application determines whether the particular program to execute selected action 440 is accessible to client device 110 (typically in flash memory). If the program is not locally available, or if there is a newer version with which the RMC application has associated selected action 440, then the RMC application transmits an action request (i.e. the selection of action 440) and the configuration for client device 110 to server 100. Server 100 compares the configuration requirements and action request with programs in storage 130 and transmits an appropriate program to client device 110.

In this example, if image 410 were the JPEG formatted version of resource 310, or “winter.jpg,” then server 100 would retrieve a different version of a program for executing a specific action on a PC than on a digital camera. Because each configuration differs, different versions of a program for executing the same action request would be transmitted to each client device 110 according to their respective configuration.

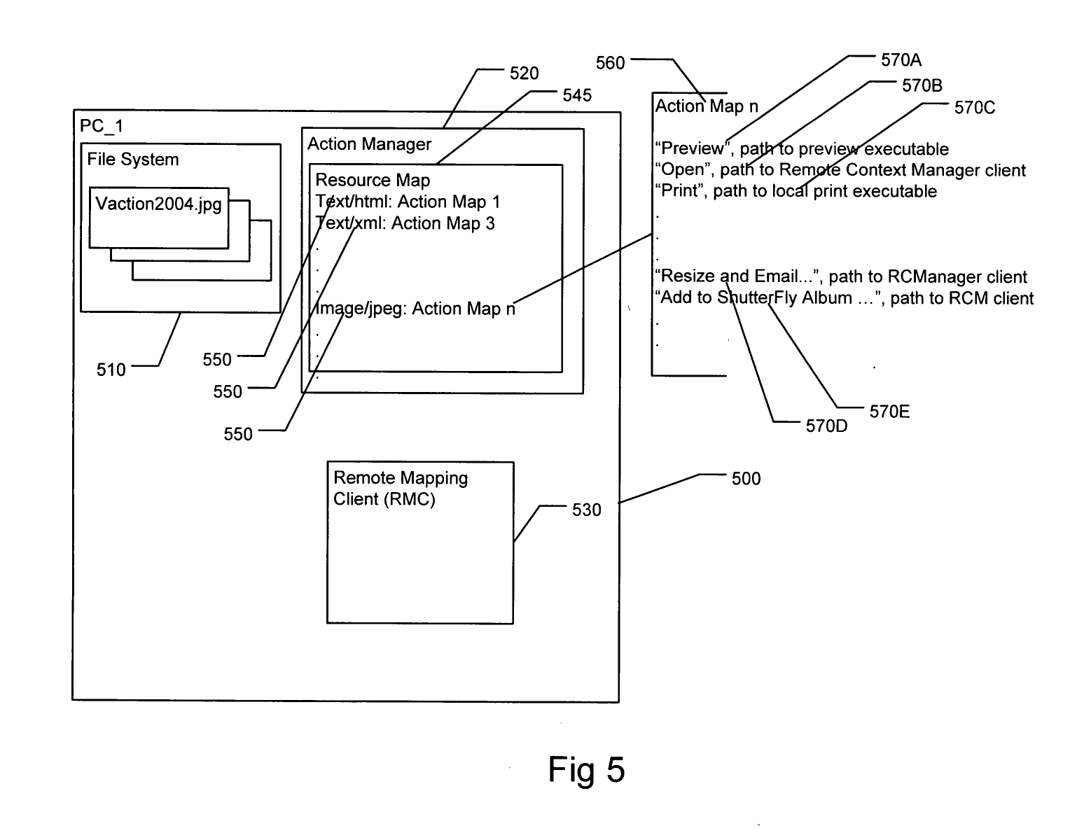

FIG. 5 is a block diagram illustrating one embodiment of a software structure for implementing the present invention within a client device. Client device 500 includes resource system 510, action manager 520, and RMC application 530.

Resource system 510 includes resources, for example resource 310 “winter.jpg” from FIG. 3, text resources, and other categories.

Action manager 520 contains at least one resource map 545 that includes different resource mappings 550. Each resource mapping 550 includes a given category of resource (commonly identified with extensions, e.g. “.doc,” “.pdf” and “.jpg”), for example, a text file, and an action map 560. Each action map 560 contains action mappings 570A through 570E. Each action mapping identifies an action request by name and an appropriate program when the action mapping is able to perform the indicated action. The action request names may be used to construct context menus for each resource category. In FIG. 5, programs are identified by the path name where they can be located. They may also be identified by universal resource locator (URL), an id used to lookup the program in a database, or other equivalent mechanism. In this manner, each resource category is associated with a set of actions and the programs that can perform the actions.

RMC application 530 is responsible for adding or customizing resource mappings 550 within action manager 520. RMC application 530 adds, deletes, or modifies resource mappings 550. Existing resource mappings 550 may be modified by adding or overriding actions mappings 570A through 570D in the action maps 560 associated with the resource mappings 550. RMC application 530 may add to or change some or all of action maps 550. Upon start-up of client device 500, a user-identification (ID) is established. In one embodiment, a server identifies the user and the appropriate resource map for that user, whether as an individual or as part of a group. The server communicates with client device 500, and client device 500 receives a resource map, which may be specific to the user ID. RMC application 530 uses the received resource map to add, delete, and/or modify resource mappings in resource map 545 within action manager 520. In this embodiment, action manager 520 has one resource mapping 550 for each category of resource and one resource map 545. In alternate embodiments, action manager 520 may maintain a distinct resource map for each user and each resource map may identify specific resources or categories of resources based on some characteristic of one or more resources.

Upon receiving an action request for which the executable program is unavailable to client device 500, the configuration information for client device 500 and the action request are sent to a server and the server determines the appropriate program for executing the action request associated with the configuration information.

Action map 560 is one example of an action map with action mappings 570A, 570B, 570C, 570D, and 570E (collectively referred to as 570) associated with resource-categories, in this example actions 570 are associated with action map 550 for the resource-category “JPEG.” Actions 570A and 570C are actions that have local executable programs, for previewing and printing, while actions 570B, 570D and 570E are associated through RMC application 530 with programs that may be on a server. Therefore, actions 570B, 570D and 570E are added to profile 560, by RMC application 530 using a resource map received from a server, at some point in time, for example at start-up for client device 500.

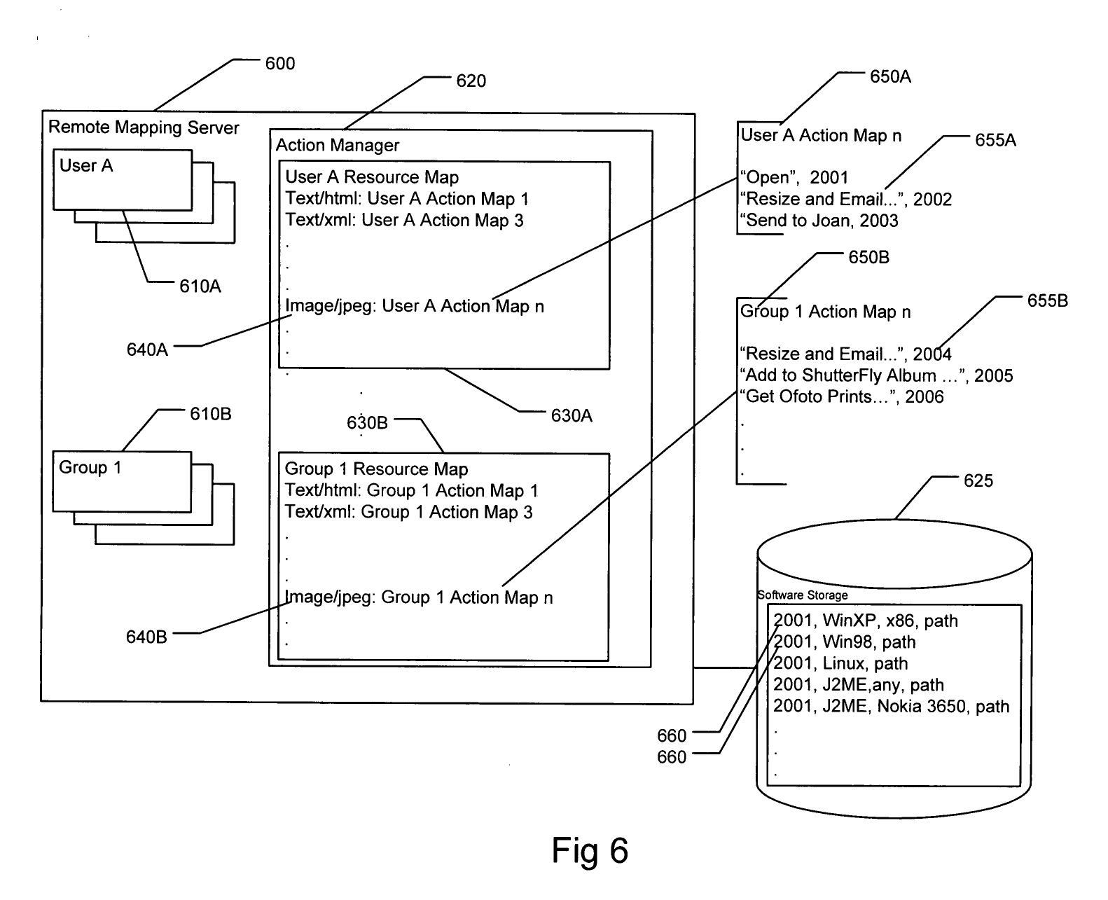

FIG. 6 is a block diagram illustrating one embodiment of the invention in a server. In this embodiment, remote mapping server (RMS) 600 includes records of users 610A and groups 610B (collectively referred to as 610) and an action manager 620, similar to the action manager on the client device but containing resource maps for multiple devices. Storage 625 may be a remote hard storage medium or other type of memory, and may be embedded within RMS 600 or connected externally. Storage 625 includes programs 660 for executing action requests on client devices with different configurations.

Users and Groups 610 in RMS 600 may include associations with resource maps 630A and 630B (collectively referred to as 630). In FIG. 6, User A 610A is associated with User A Resource Map 630A, and members of Group 1 610B are associated with Group 1 Resource Map 630A. Note, that in this embodiment a user may belong to one or more groups such that one or more resource maps may be associated with said user. In this embodiment, a client device may transfer a user ID to RMS 600, which enables server 600 to determine which user and group accounts 610 the user of the device is associated with, and thereby which resource maps 630 are transferred to the client device. This transfer may occur each time a client device is powered up, each time a user logs on, or less frequently. If more than one resource map 630 is associated with a client device, the RMS 600 may merge the maps before transferring them to the client. Optionally, if multiple resource maps are sent to the client, the client may merge the maps. The policy for merging two or more resource maps is implementation specific and may be configurable and may vary depending on the user, group(s), and device.

Action manager 620 is similar to the action manager on the client. It contains resource maps 630 that are associated with a device, users, and/or groups. There are different ways to associate a resource map with a device in a given situation. Resource maps 630 contain resource mappings 640A and 640B (collectively referred to as 640). Resource mappings 640 associate specific resources or categories of resources with action maps 650A and 650B (collectively referred to as 650). Each action map 650 contains action mappings 655 that map actions to executables, which can perform the indicated actions.

If a user associated with the record for User A 630A, and not associate with any group is using a client device, then resource map 630A is provided to the client device. If the user right-clicks on a mouse with a “.jpg” resource selected, actions 650A would be available as some or all of the possible actions. If a user associated with the record for User A 630A and with Group 1 630b, then a resource map resulting from the merging of resource map 640A and 640B is provided to the device. If the merge policy implements a rule that indicates that user preferences override group preferences then the merged resource map references action mapping 655A and not action mapping 655B since 655A and 655B refer to the same action request. In this manner, the actions for resources on multiple machines can be managed from a central location, by the user, an information technology (IT) department, or a software distributor, for example.

Once an action request is received by an RMC application and the program for executing the action is not available within the client device, the request and configuration information regarding the client device is sent to RMS 600. RMS 600 locates the action request in the associated action mapping 650. In the preferred embodiment, each action mapping provides an id that identifies a group of executables that can perform the indicated action. The request contains configuration information that is used to determine the appropriate program 660 in the group of programs for executing the action request. In one embodiment, server 600 determines, based on a particular configuration, which program will suffice. In another embodiment, server 600 transmits a request for a program and storage 130 determines, based on the configuration information, the appropriate version of program 660.

A given action request may be executed by versions of a program that run on different OSs, with different microprocessors, and different amounts of memory, for example. Once an appropriate program 660 is located, it may be transferred to the client device for one-time use, temporary use, or long-term/permanent use depending on licensing arrangements and other agreements or the user's need.

In another embodiment, the invention may use URLs to identify a remote executable stored somewhere on the Internet, allowing a web server to be the front-end server. Note that alternate embodiments of the invention could process some actions on the server rather than transferring an executable to the client.

The system may be provided as a service where the provider charges for actions it supports, for example a download of PHOTOSHOP for some defined period of use. Billing may be on a per use basis, flat rate for a period of time, etc. For example, an Internet service provider (ISP) may provide additional services to its customers by associating actions with resource categories.

The advantages of the invention include: it extends the range of available actions beyond those available on local or network attached storage; it allows actions and associated software to be centrally managed and tracked; it allows upgrades to be installed in one location which automatically distributes the upgrades on an as needed basis; and it allows software associated actions and the resource/action/executable maps to be stored remotely and used on the client on an as needed basis. This is significant for handhelds and other devices with limited resources, e.g. cell phones, digital camera, PDAs, etc.

The invention allows the resource maps to be determined dynamically and to be customized per user, per machine, per group. The resource map can be managed securely from a central location. The invention further provides for a wide variety of billing options for software providers, for example bill per install; bill per use; and bill per period.

Various client devices and a server may include a processor, memory, a bus, an input/output (I/O) device, a power supply, and so forth in order to operate. The various combinations and configurations of hardware are not necessary for one of ordinary skill in the art to understand and implement the invention, and are not included in this description in order to avoid obscuring the invention.

Thus the invention is to be limited only by the appended claims. Although the invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A system for linking resources with actions comprising:
a client device having access to a resource map that associates an action request with a resource-category, and in response to receiving the action request, is configured to use the resource map to retrieve a program for executing the action request, and to execute the program to perform the action request; and
a server configured to communicate with the client device over a network, to maintain the resource map, and to provide the resource map to the client device.

2. The system of claim 1 wherein the server is further configured to maintain access to the program and transmit the program to the client device upon a request from the client device for the program.

3. The system of claim 2 wherein the client device is further configured to receive the program in order to perform the action request.

4. The system of claim 3 wherein the server is further configured to allow the user to customize the resource map.

5. The system of claim 2, the client device having a configuration specific to the client device, wherein the client device is further configured to transmit to the server the configuration specific to the client device.

6. The system of claim 5 wherein the program is one of a plurality of programs, each of the plurality of programs configured to execute the action request in a different configuration.

7. The system of claim 6 wherein the server is further configured to receive the configuration specific to the client device and the request for the program, and to determine with a remote mapping server (RMS) application whether one of the plurality of programs satisfies the configuration specific to the client device.

8. The system of claim 7 wherein the server is further configured to transmit to the client device one of the plurality of programs for executing the action request in the configuration specific to the client device.

9. The system of claim 5 wherein the configuration specific to the client device includes an operating system type.

10. The system of claim 5 wherein the configuration specific to the client device includes a processor type and a memory size.

11. A client device for linking resources with actions, the client device configured to communicate with a server over a network, the client device comprising:
a processor configured to process an action request; and
a memory coupled to the processor, the memory having an Remote Mapping Client (RMC) application configured to receive a resource map that associates the action request with a resource-category, and in response to receiving the action request, to use the resource map to retrieve a program for executing the action request.

12. The device of claim 11 wherein the RMC application is further configured to transmit a request for the program.

13. The device of claim 12 further configured to receive the program.

14. The device of claim 11 wherein the resource map is customizable by the user.

15. The device of claim 12, the client device having a configuration specific to the client device and wherein the RMC application is further configured to transmit the configuration specific to the client device.

16. The device of claim 15 wherein the program is one of a plurality of programs, each of the plurality of programs configured to execute the action request in a different configuration.

17. The device of claim 15 wherein the configuration specific to the client device includes an operating system type.

18. The device of claim 15 wherein the configuration specific to the client device includes a processor type and a memory size.

19. The device of claim 16 further configured to receive one of the plurality of programs for executing the action request, in the configuration specific to the client device, from the server.

20. The device of claim 13 further configured to retain the program for executing the action request for further use.

21. The device of claim 19 further configured to retain for further use one of the plurality of programs for executing the action request, in the configuration specific to the client device.

22. A server for linking resources with actions, the server configured to communicate with a client device, the client device configured to receive an action request from a user and having a configuration specific to the client device, the server comprising:
a processor configured to transmit to the client device a resource map that associates the action request with a resource-category; and
a memory coupled to the processor, the memory configured to maintain the resource map.

23. The server of claim 22 wherein the memory is further configured to maintain access to a program for executing the action request and to transmit the program to the client device upon a request from the client device for the program.

24. The server of claim 23 further configured to allow the user to customize the resource map.

25. The server of claim 23 wherein the program is one of a plurality of programs, each of the plurality of programs configured to execute the action request in a different configuration.

26. The server of claim 25 further configured to receive the configuration specific to the client device and the request for the program, and to determine with a remote mapping server (RMS) application whether one of the plurality of programs for executing the action request satisfies the configuration specific to the client device.

27. The server of claim 26 further configured to transmit one of the plurality of programs for executing the action request in the configuration specific to the client device.

28. The server of claim 26 wherein the configuration specific to the client device includes an operating system type.

29. The server of claim 26 wherein the configuration specific to the client device includes a processor type and a memory size.

30. A method for linking resources with actions in a client device in communication with a server over a network, the method comprising:
receiving a resource map from the server that associates an action request with a resource-category;
registering the resource map with the client device; and
retrieving a program for executing the action request on the client device.

31. The method of claim 30 further comprising:
requesting the program for executing the action request from the server if the program is not present on the client device.

32. The method of claim 31 further comprising:
executing the action request with the program.

33. The method of claim 32 further comprising:
altering the resource map.

34. The method of claim 30 further comprising:
transmitting to the server the configuration specific to the client device.

35. The method of claim 34 wherein the program is one of a plurality of programs, each of the plurality of programs configured to execute the action request in a different configuration.

36. The method of claim 35 further comprising:
receiving the configuration specific to the client device; and
determining whether one of the plurality of programs satisfies the configuration specific to the client device.

37. The method of claim 36 further comprising:
transmitting one of the plurality of programs for executing the action request in the configuration specific to the client device.

38. The method of claim 37 wherein the configuration specific to the client device includes an operating system type.

39. The method of claim 37 wherein the configuration specific to the client device includes a processor type and a memory size.

40. A computer readable medium containing programming instructions for linking resources with actions in a client device in communication with a server over a network, the programming instructions for:
receiving a resource map that associates an action request with a resource-category;
registering the resource map with the client device; and
retrieving a program for executing the action request on the client device.

41. The computer readable medium of claim 40, the instructions further comprising:
requesting the program for executing the action request from the server if the program is not present on the client device.

42. The computer readable medium of claim 41, the instructions further comprising:
executing the action request through the program.

43. The computer readable medium of claim 41, the instructions further comprising:
altering the resource map.

44. The computer readable medium of claim 40, the instructions further comprising:
transmitting to the server the configuration specific to the client device.

45. The computer readable medium of claim 44 wherein the program is one of a plurality of programs, each of the plurality of programs configured to execute the action request in a different configuration.

46. The computer readable medium of claim 45, the instructions further comprising:
receiving the configuration specific to the client device; and
determining whether one of the plurality of programs satisfies the configuration specific to the client device.

47. The computer readable medium of claim 46, the instructions further comprising:
transmitting one of the plurality of programs for executing the action request in the configuration specific to the client device.

48. The computer readable medium of claim 47 wherein the configuration specific to the client device includes an operating system type.

49. The computer readable medium of claim 47 wherein the configuration specific to the client device includes a processor type and a memory size.

50. A client device comprising:
a processor; and
a memory coupled to the processor and having a current resource map associating an action request with a program for executing the action request, and a Remote Mapping Client (RMC) application configured to receive a new resource map, and further configured to alter the current resource map using the new resource map.

51. A system for linking resources with actions comprising:
a client device having access to a resource map that associates an action request with a resource-category, and in response to receiving the action request, configured to use the resource map to transmit the action request; and
a server configured to communicate with the client device over a network, to maintain the resource map, to provide the resource map to the client device, to receive the action request, and to execute a program for performing the action request.
